(19) United States
(12) Patent Application Publication
(10) Pub. No.: US 2001/0026400 A1
(43) Pub. Date: Oct. 4, 2001

(54) Dual-use visible-light/infrared image pickup device

(75) Inventor: Kazuo Yoshikawa, Omiya-shi (JP)

Correspondence Address: Ronald R. Snider, Snider & Associates, P.O. Box 27613, Washington, DC, 20038-7613, US

(73) Assignee: Fuji Photo Optical Co., Ltd., Omiya-shi (JP)

(21) Appl. No.: 09/805,227

(22) Filed: Mar. 14, 2001

(30) Foreign Application Priority Data
Mar. 28, 2000 (JP) 2000-087774

(51) Int. Cl. G02B 15/14

(52) U.S. Cl. 359/676; 359/678; 359/679

(57) ABSTRACT

A shift in focal point due to longitudinal chromatic aberration of a photographing lens is properly corrected in accordance with various photographing conditions, by means of controlling the thickness of a variable-thickness optical filter interposed between an image pickup lens system and a solid-state image pickup element, on the basis of a correlation table defining the correlation between photographing conditions and the thickness of the variable-thickness optical filter that can correct a shift in focal point. A variable-thickness optical filter is interposed between a photographing lens system and a CCD having sensitivity ranging from the visible-light range to the infrared range. The thickness of the optical filter is changed, by means of controlling an actuator on the basis of a correlation table defining the correlation between the photographing conditions and the thickness of the variable-thickness optical filter which can correct the shift in optical focal point. The variable-thickness optical filter is formed from two wedge-shaped prisms combined together to form a parallel-plane plate, and the overall thickness of the variable-thickness optical filter can be changed, by means of moving the prisms in opposite directions while oblique lines of the prisms remain in contact with each other.

### RELATED APPLICATION

This application claims the priority of Japanese Patent Application No. 2000-087774 filed on Mar. 28, 2000, which is incorporated herein by reference.

### BACKGROUND OF THE INVENTION

1. Field of the Invention

The present invention relates to a visible-light/infrared image pickup device having sensitivity ranging from the visible light range to the infrared (IR) range, and more particularly, to a visible-light/infrared image pickup device capable of correcting a shift in focal point caused by longitudinal chromatic aberration which would arise depending on image pickup conditions.

2. Description of the Prior Art

In the field of cameras using solid-state image pickup elements, a solid-state image pickup element whose spectral sensitivity extends from the visible-light range to the infrared range has recently been developed. A camera employing such a solid-state image pickup element is also known.

Since infrared radiation is suitable for night photographing, attention has been paid to use of such a camera, particularly as a round-the-clock monitoring camera.

However, the amount of longitudinal chromatic aberration arising in an image pickup lens in the visible-light range greatly differs from that arising in the image pickup lens in the near-infrared range. Hence, the focal point of the image pickup lens in the visible light range deviates from that of the image pickup lens in the near-infrared range. FIG. 3A shows that longitudinal chromatic aberration greatly changes in accordance with wavelength.

In a case where a solid-state image pickup element is used in a stationary state, when the focal point of the element is set for one wavelength range, the element goes out of focus in the other wavelength range, thereby failing to capture the best image.

A conceivable method of correcting a shift in the focal point is to move the solid-state image pickup element in accordance with wavelength. However, moving an image surface is not preferable in terms of maintaining optical performance.

Interposing a filter between the solid-state image pickup element and a photographing lens such that the filter is replaced with another filer of different thickness in accordance with wavelength, such as that shown in FIG. 6, has already been known.

Particularly in the case of near-infrared radiation, the amount of longitudinal chromatic aberration arising in the photographing lens greatly varies in accordance with the focal length (zoom setting) of the photographing lens, as well as with wavelength. This phenomenon is shown in FIG. 3B. The amount of longitudinal chromatic aberration is also greatly changed in accordance with the brightness and focal position of a photographing lens and the aperture of a diaphragm.

When an attempt is made to apply the related-art technology to various photographing conditions, a plurality of optical filters of different thicknesses must be prepared, which is considered to be difficult in practice.

The present invention has been conceived against such a backdrop and is aimed at providing a dual-use visible-light/infrared image pickup device which can correct a shift in the position of a focal point attributable to the longitudinal chromatic aberration of a photographing lens, in accordance with various photographing conditions.

### SUMMARY OF THE INVENTION

To this end, the present invention provides a dual-use visible-light/infrared image pickup device including an image pickup element having sensitivity ranging from the visible-light range to the infrared range and means for correcting a shift in focal point, which would otherwise be caused by longitudinal chromatic aberration arising in a photographing lens, the device comprising:

a variable-thickness optical filter interposed between a photographing lens system and the image pickup element of solid state;

an actuator for changing the thickness of the variable-thickness optical filter;

memory for storing a correlation table defining the correlation between the photographing conditions and the thickness of the variable-thickness optical filter at which the shift in optical point can be corrected; and

thickness control means for controlling the actuator on the basis of the correlation table stored in the memory.

Preferably, the variable-thickness optical filter is formed from two wedge-shaped prisms combined together to form a parallel-plane plate, and the overall thickness of the variable-thickness optical filter can be changed by means of moving the prisms in opposite directions while oblique lines of the prisms remain in contact with each other. Alternatively, the variable-thickness optical filter is constructed such that the overall thickness thereof can be changed by means of shifting liquid filled in the space defined between the two parallel plates. However, the variable-thickness optical filter is not limited to these two types.

Preferably, the photographing conditions correspond to at least one of the wavelength of incident light, the brightness of the photographing lens system, the brightness of a subject, a zoom magnification, a focal point, and the aperture of a diaphragm. However, the photographing conditions are not limited to these factors.

Preferably, the photographing lens is a zoom lens. Alternatively, the photographing lens is a fixed-focus lens.

Preferably, the image pickup device is a monitoring camera.

### BRIEF DESCRIPTION OF THE DRAWINGS

FIG. 1 is a schematic view showing a dual-use visible-light/infrared image pickup device according to Example 1 of the present invention;

FIG. 2 is a schematic view showing a dual-use visible-light/infrared image pickup device according to Example 2 of the present invention;

FIGS. 3A and 3B are graphs showing variations in longitudinal chromatic aberration corresponding to photographing conditions;

FIG. 4 is a schematic view showing an actuator movement mechanism according to Example 2;

FIG. 5 is a block diagram showing a thickness variation system according to Example 2; and

FIG. 6 is a schematic view showing a thickness variation system according to the prior art.

### DESCRIPTION OF THE PREFERRED EMBODIMENTS

A dual-use visible-light/infrared image pickup device according to a preferred embodiment of the present invention will be described hereinbelow by reference to the accompanying drawings.

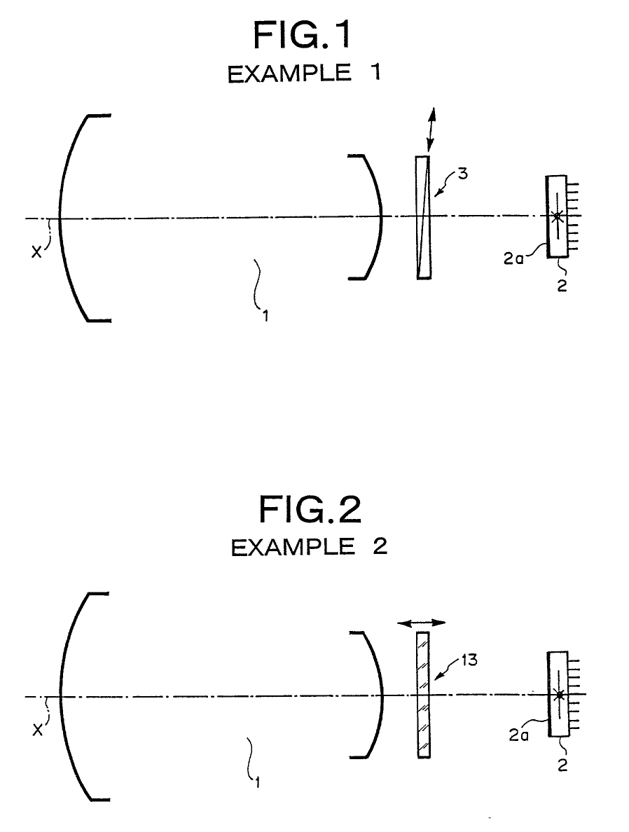

FIG. 1 is a schematic view showing the principal construction of the dual-use visible-light/infrared image pickup device according to Example 1 of the present invention. Light carrying an image of a subject is focused to form an image on an image-forming surface 2a of a CCD 2, by means of a photographing lens 1. The amount of longitudinal chromatic aberration arising in the photographing lens 1 is greatly changed in accordance with wavelength. The CCD 2 has sensitivity over a wide range of wavelength ranging from the visible-light range to the near-infrared range. The image pickup device can be used in both day and night. The amount of longitudinal chromatic aberration which arises in the photographing lens 1 during daytime photographing using primarily light of visible-light range greatly differs from the amount of longitudinal chromatic aberration which arises in the photographing lens 1 during nighttime photographing using a large proportion of near-infrared radiation. If the image-forming surface 2a of the CCD 2 is set in a position suitable for daytime photographing, an image captured during nighttime photographing becomes blurred.

In Example 1, two wedge-shaped prisms are combined together to form a parallel-plane plate, thereby forming a variable-thickness optical filter 3 whose overall thickness can be changed by means of sliding the prisms away from or close to each other along tapered surfaces of the prisms. The optical filter 3 is interposed between the photographing lens 1 and the CCD 2 along an optical axis X. In accordance with the wavelength of the light entering the photographing lens 1, the thickness of the optical filter 3 is changed, thereby correcting a shift in the focal point.

The variable-thickness optical filter 3 is slid by means of a known actuator. A thickness-variation system including the actuator will be described later.

FIG. 2 is a schematic view showing the principal construction of the dual-use visible-light/infrared image pickup device according to Example 2 of the present invention. A variable-thickness optical filter 13 according to Example 2 is formed by means of arranging two glass plates in parallel with each other and sealing predetermined liquid between the glass plates. By means of a shift in liquid, the overall thickness of the optical filter 13 can be changed. The thickness of the filter 13 is changed by use of an actuator for use with a vari-angle prism described in, for example, Japanese Unexamined Patent Publication No. 8(1996)-39861.

A thickness-variation system may be constructed in the same manner as that described in connection with Example 1.

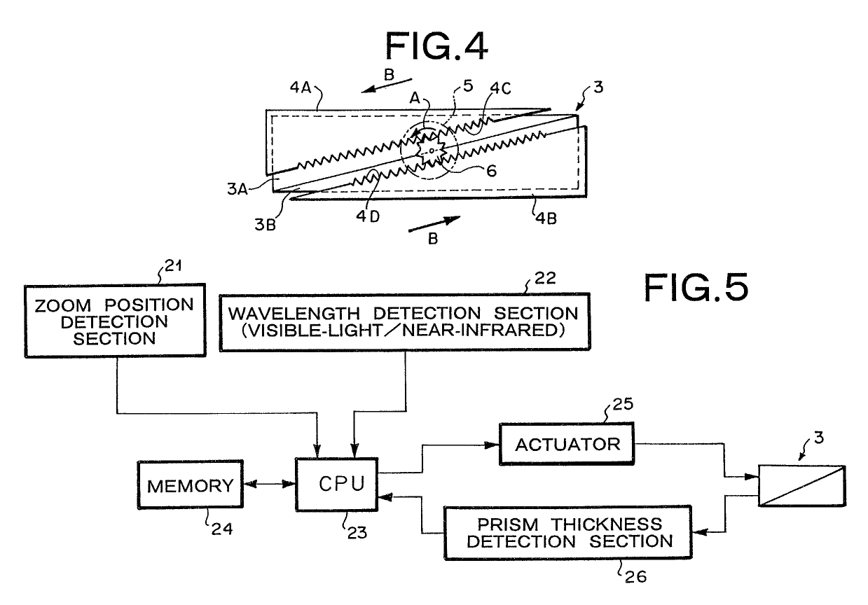

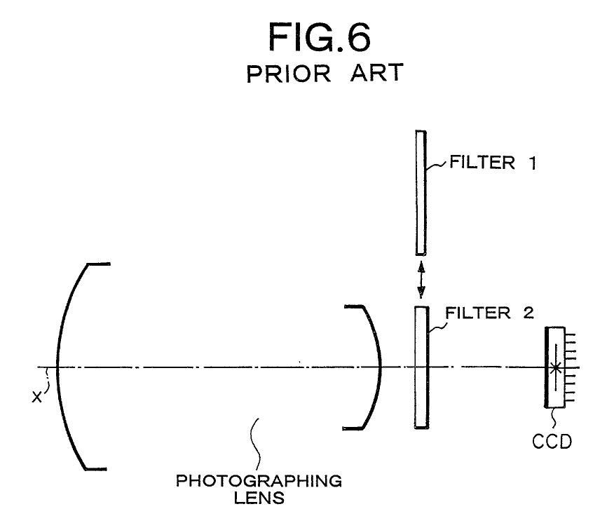

FIG. 4 shows an actuator movement mechanism of the variable-thickness optical filter 3. FIG. 4 shows the side view of the variable-thickness optical filter 3.

In wedge-shaped prisms 3A and 3B constituting the variable-thickness optical filter 3, a rack plate 4A which is substantially identical in shape with the prism 3A is attached to the side surface of the prism 3A. Further, a rack plate 4B which is substantially identical in shape with the prism 3B is attached to the side surface of the prism 3B. A rack 4C is formed in an oblique side of the rack plate 4A, and a rack 4D is formed in an oblique side of the rack plate 4B. A pinion 6 attached to a rotation shaft of a motor 5 serving as an actuator is arranged so as to mesh with the racks 4C and 4D. When the pinion 6 is rotated in the direction designated by arrow A as a result of rotation of the motor 5, the prism 3A integrated with the rack plate 4A and the prism 3B integrated with the rack plate 4B are moved in the directions designated by arrows B, whereby the overall thickness of the optical filter 3 is reduced.

As a matter of course, if the motor 5 is rotated in the reverse direction while the optical filter 3 is of reduced thickness, the thickness of the optical filter 3 is increased.

The thickness variation system according to Example 2 will be described by reference to FIG. 5. The thickness variation system comprises a zoom position detection section 21; a wavelength detection section 22; a CPU 23 which receives zoom position information output from the zoom position detection section 21 and wavelength information output from the wavelength detection section 22 and acts as computation means; memory 24 storing a table having set therein the correlation between photographing conditions and the thickness of the optical filter 3 which can correct a shift in focal point due to variations in longitudinal chromatic aberration; an actuator 25 which enables changing of the thickness of the optical filter 3 in accordance with a thickness variation instruction signal output from the CPU 23; and a prism thickness detection section 26 which feeds back to the CPU 23 information about the current thickness of the optical filter 3.

Although FIG. 5 shows that only zoom position information and wavelength information are input to the CPU 23, the thickness variation system may be arranged such that focus position information, brightness-of-subject information, brightness-of-lens information, and aperture-of-diaphragm information are also input to the CPU 23, as required.

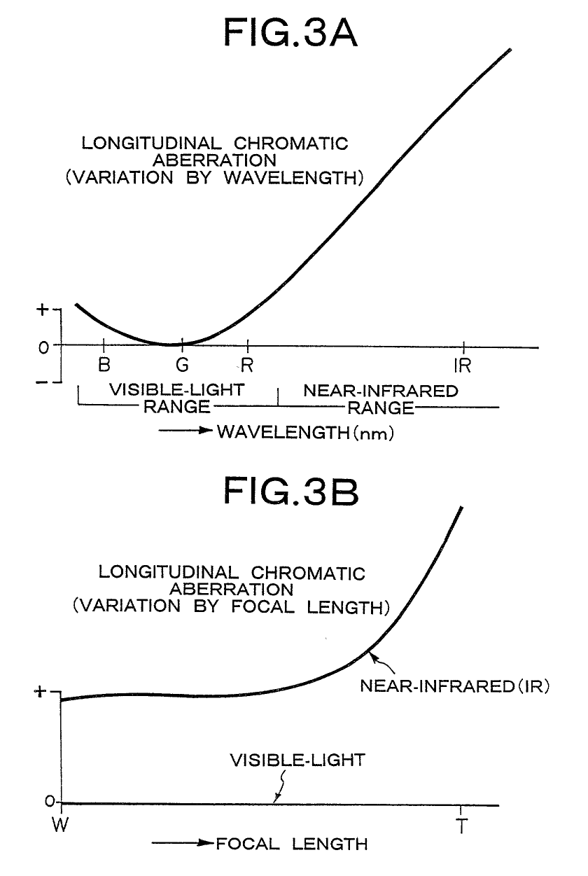

Preferably, correlation is specified as the correlation table stored in the memory 24 in consideration of the foregoing information pieces which are input as photographing conditions to the CPU 23, as required. The relationship between the information pieces and longitudinal chromatic aberration (i.e., the relationship shown in FIGS. 3A and 3B) is determined beforehand, and the correlation table is defined on the basis of the thus-determined relationship.

On the basis of the various information pieces pertaining to the photographing conditions entered from the CPU 23, the thickness variation system having the foregoing configuration accesses the memory 24, thereby obtaining from the correlation table a thickness appropriate for the optical filter 3 under the current conditions. The CPU 23 outputs a thickness variation instruction signal to the actuator 25 such that the optical filter 3 assumes an appropriate thickness. Here, information about the current thickness of the optical filter 3 is supplied to the CPU 23 from the prism thickness detection section 26. Hence, the CPU 23 outputs, to the actuator 25, a thickness variation signal corresponding to a difference between an appropriate thickness and the current thickness of the optical filter 3.

The dual-use visible-light/infrared image pickup device according to the present invention is not limited to the devices described in connection with the previous examples. In a case where a photographing lens is a fixed focus lens, correlation data pertaining to the zoom information are unnecessary.

The two above-described dual-use visible-light/infrared image pickup devices are useful particularly for round-the-clock monitoring cameras (monitoring cameras or like cameras). However, the image pickup devices can also be applied to various other types of cameras. For instance, the image pickup device can also be applied to an image pickup camera for an aircraft or to CCD-equipped binoculars.

As has been described above, in a dual-use visible-light/infrared image pickup device according to the present invention, the thickness of a variable-thickness optical filter interposed between an image pickup lens system and a solid-state image pickup element is controlled on the basis of a correlation table defining the correlation between photographing conditions and the thickness of the thickness-variable optical filter that can correct a shift in focal point. As a result, a shift in focal point due to longitudinal chromatic aberration of a photographing lens can be corrected in accordance with various photographing conditions. As a result, a blur-free, good image can be captured in either daytime photographing using primarily visible light and nighttime photographing using primarily near-infrared radiation.

What is claimed is:

1. A dual-use visible-light/infrared image pickup device including an image pickup element having sensitivity ranging from the visible-light range to the infrared range and means for correcting a shift in focal point, which would otherwise be caused by longitudinal chromatic aberration arising in a photographing lens, the device comprising:
a variable-thickness optical filter interposed between a photographing lens system and said image pickup element of solid state;
an actuator for changing the thickness of said variable-thickness optical filter;
memory for storing a correlation table defining the correlation between said photographing conditions and the thickness of said variable-thickness optical filter which can correct said shift in optical point; and
thickness control means for controlling said actuator on the basis of said correlation table stored in said memory.

2. The dual-use visible-light/infrared image pickup device according to claim 1, wherein said variable-thickness optical filter is formed from two wedge-shaped prisms combined together to form a parallel-plane plate, and the overall thickness of said variable-thickness optical filter can be changed, by means of moving said prisms in opposite directions while oblique lines of said prisms remain in contact with each other.

3. The dual-use visible-light/infrared image pickup device according to claim 1, wherein said variable-thickness optical filter is constructed such that the overall thickness of said variable-thickness optical filter can be changed by means of shifting liquid filled in the space defined between the two parallel plates.

4. The dual-use visible-light/infrared image pickup device according to claim 1, wherein the photographing conditions correspond to at least one of the wavelength of incident light, the brightness of said photographing lens system, the brightness of a subject, a zoom magnification, a focal point, and the aperture of a diaphragm.

5. The dual-use visible-light/infrared image pickup device according to claim 1, wherein said photographing lens is a zoom lens.

6. The dual-use visible-light/infrared image pickup device according to claim 1, wherein said photographing lens is a fixed-focus lens.

7. The dual-use visible-light/infrared image pickup device according to claim 1, wherein said image pickup device is a monitoring camera.
